(19) United States
(12) Patent Application Publication
(10) Pub. No.: US 2013/0314329 A1
(43) Pub. Date: Nov. 28, 2013

(54) TOUCH PANEL DETECTION DEVICE

(71) Applicants: Tzyy-Pyng Lin, New Taipei City (TW); Fu-Kuei Chang, New Taipei City (TW); Kuei-Ying Chan, Sinjhuang City (TW); Jhih-Wun Syu, Sinjhuang City (TW)

(72) Inventors: Tzyy-Pyng Lin, New Taipei City (TW); Fu-Kuei Chang, New Taipei City (TW); Kuei-Ying Chan, Sinjhuang City (TW); Jhih-Wun Syu, Sinjhuang City (TW)

(21) Appl. No.: 13/480,211

(22) Filed: May 24, 2012

(51) Int. Cl. G06F 3/041

(52) U.S. Cl. 345/173

(57) ABSTRACT

A touch panel detection device includes a substrate, at least one first and at least one second transmitter, at least one first and at least one second receiver and a connection unit. The substrate is a frame body having opposed first and second sides and opposed third and fourth sides. A first fixing section and a second fixing section are respectively disposed on the first and second sides. A third fixing section and a fourth fixing section are respectively disposed on the third and fourth sides. Opposed fixing sections are respectively parallelly arranged and misaligned from each other. The first and second transmitters are respectively disposed on the first and third fixing sections, while the first and second receivers are respectively disposed on the second and fourth fixing sections.

### BACKGROUND OF THE INVENTION

1. Field of the Invention

The present invention relates to a touch panel detection device in which the transmitters and receivers are arranged on the substrate and misaligned from each other so as to solve the problem of detection blind corners of the conventional touch screen.

2. Description of the Related Art

Along with the continuous advance of sciences and technologies, there is a trend in the commercially available electronic products to have smaller and smaller volume, while larger and larger screen. Such electronic product generally is free from any operation pushbutton and has a touch screen for a user to directly operate the electronic product.

Infrared touch control technique is the most popular technique for the existent large-size touch screens. The infrared touch screen basically includes a touch substrate and multiple transmitters and multiple receivers mounted on a periphery of the touch substrate in a certain sequence. The transmitters and receivers are one-to-one correspondingly arranged to form a tidily interlaced infrared ray network. That is, a perpendicular transmission/receiving array is formed along the periphery of the touch substrate. Under the control of a processor, the corresponding transmitters and receivers are respectively connected in a certain sequence to detect whether the infrared rays between the corresponding transmitters and receivers are interrupted so as to judge whether a touch takes place.

Please refer to FIG. 1. The conventional touch panel detection device includes a substrate 1, multiple transmitters 10 and multiple receivers 11 arranged on the periphery of the substrate 1. The transmitters 10 and receivers 11 are one-to-one arranged to form an infrared touch matrix. According to such arrangement, a mass of LED module transmitters 10 and receivers 11 are needed. Please refer to FIG. 2. Another type of conventional touch panel detection device employs a receiver 11 to receive infrared rays transmitted from multiple transmitters 10. The multiple transmitters 10 transmit the infrared rays in sequence for the receiver 11 to judge whether the light path is interrupted. Please refer to FIG. 3. Still another type of conventional touch panel detection device employs a transmitter 10 and multiple receivers 11 to form multiple infrared connection lines. In any of the above substrates 1, each light path can only provide one touch point. Therefore, the space of the light path cannot be fully utilized to provide more touch points. Accordingly, the space of the substrate 1 is not efficiently utilized. Moreover, many blind corners exist on the substrate 1.

According to the above, the conventional technique has the following shortcomings:

1. Blind corners exist on the substrate.

2. The touch is vague and unclear.

3. The space of the substrate is not fully utilized.

### SUMMARY OF THE INVENTION

It is therefore a primary object of the present invention to provide a touch panel detection device, which can solve the problems of blind corners and vague touch of the conventional touch screen.

It is a further object of the present invention to provide the above touch panel detection device in which the space of the substrate can be more efficiently utilized.

To achieve the above and other objects, the touch panel detection device of the present invention includes a substrate, at least one first transmitter, at least one second transmitter, at least one first receiver, at least one second receiver and a connection unit. The substrate is a frame body having a first side, a second side opposite to the first side, a third side and a fourth side opposite to the third side. At least one first fixing section and at least one second fixing section are respectively disposed on the first and second sides. At least one third fixing section and at least one fourth fixing section are respectively disposed on the third and fourth sides. The first and second fixing sections are parallelly arranged and misaligned from each other. The third and fourth fixing sections are parallelly arranged and misaligned from each other. The first and second transmitters are respectively disposed on the first and third fixing sections, while the first and second receivers are respectively disposed on the second and fourth fixing sections. A terminal of the connection unit is electrically connected to the first and second transmitters and the first and second receivers.

According to the above arrangement, the first and second transmitters and the first and second receivers are parallelly arranged and misaligned from each other. Therefore, the infrared rays transmitted from the first and second transmitters are received by the corresponding first and second receivers to form a range of light paths that covers the entire space of the substrate. In contrast, in the conventional touch screen, the transmitters and receivers are parallelly arranged and aligned with each other. Therefore, the infrared rays transmitted from the transmitters are simply perpendicularly projected to the corresponding receivers. As a result, the range of light paths cannot be enlarged. This will cause detection blind corners on the substrate. The present invention solves the above problem and the space of the substrate of the present invention can be fully utilized without any blind corner. Also, the problem of vague touch of the conventional touch screen is eliminated.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic diagram of a conventional touch panel detection device;

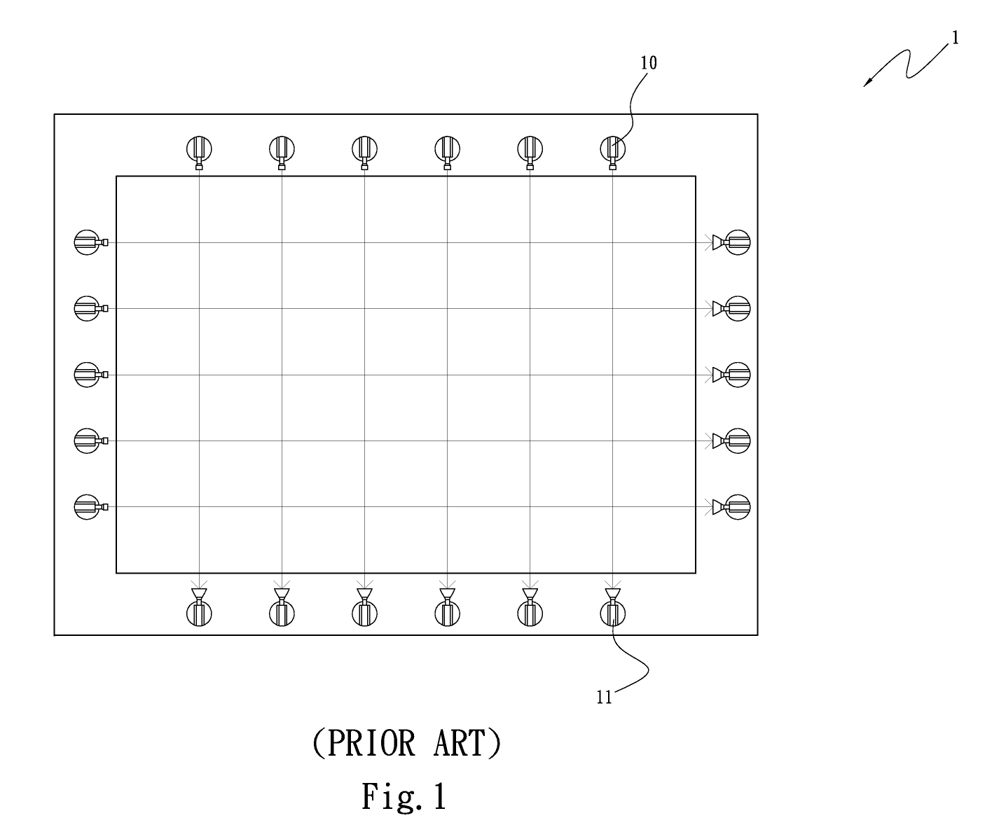

FIG. 2 is a schematic diagram of another type of conventional touch panel detection device;

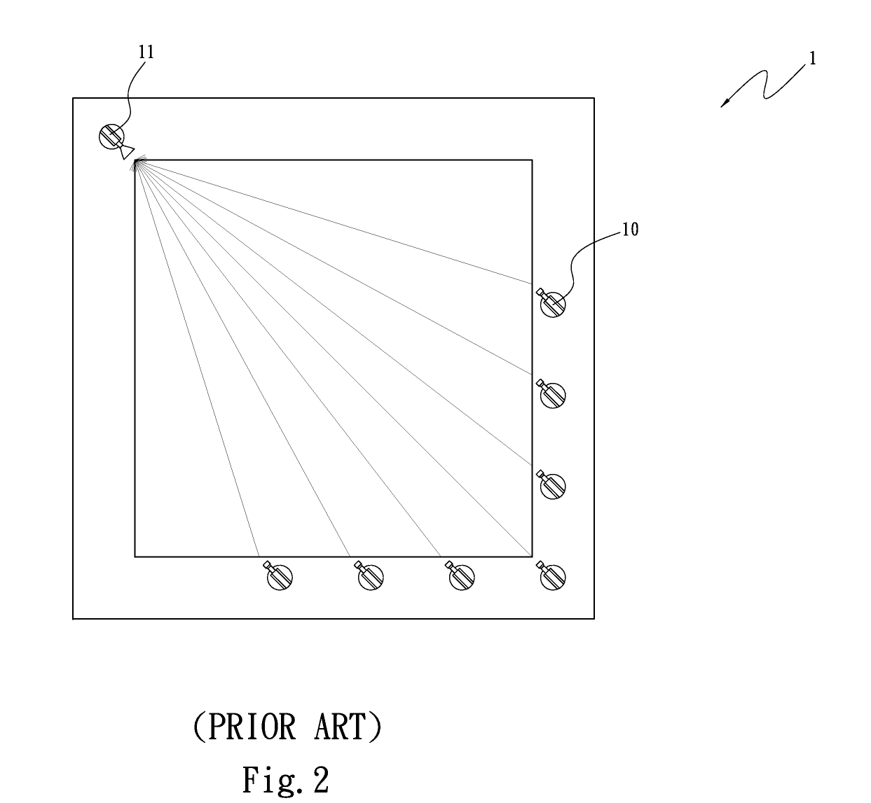

FIG. 3 is a schematic diagram of still another type of conventional touch panel detection device;

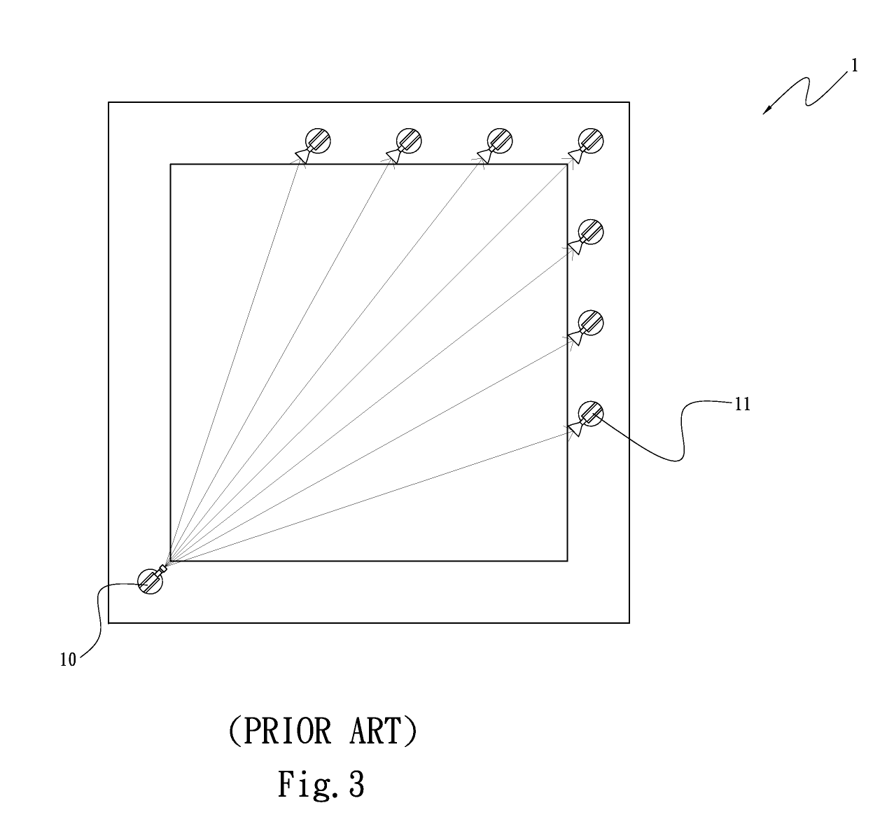

FIG. 4 is a schematic diagram of a first embodiment of the touch panel detection device of the present invention; and

FIG. 5 is a schematic diagram of a second embodiment of the touch panel detection device of the present invention.

### DETAILED DESCRIPTION OF THE PREFERRED EMBODIMENTS

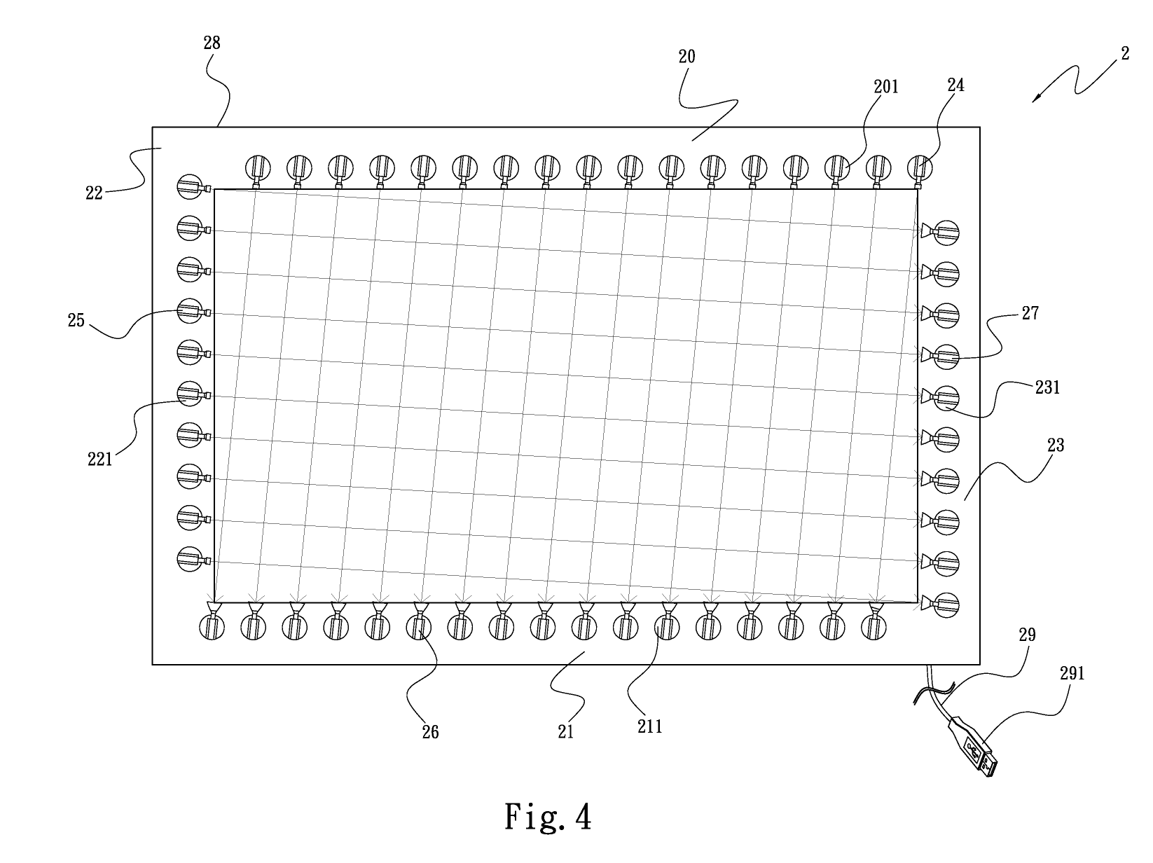

Please refer to FIG. 4, which is a schematic diagram of a first embodiment of the touch panel detection device of the present invention. According to the first embodiment, the touch panel detection device of the present invention includes a substrate 2, at least one first transmitter 24, at least one second transmitter 25, at least one first receiver 26, at least one second receiver 27 and a connection unit 29. The substrate 2 is a frame body 28 having a first side 20, a second side 21 opposite to the first side 20, a third side 22 and a fourth side 23 opposite to the third side 22. At least one first fixing section 201 and at least one second fixing section 211 are respectively disposed on the first and second sides 20, 21. At least one third fixing section 221 and at least one fourth fixing section 231 are respectively disposed on the third and fourth sides 22, 23. The first and second fixing sections 201, 211 are parallelly arranged and misaligned from each other. The third and fourth fixing sections 221, 231 are parallelly arranged and misaligned from each other.

The first transmitter 24 is disposed on the first fixing section 201, the second transmitter 25 is disposed on the third fixing section 221, the first receiver 26 is disposed on the second fixing section 211, while the second receiver 27 is disposed on the fourth fixing section 231. The first and second transmitters 24, transmit bifurcated light beams, which are infrared rays.

A terminal of the connection unit 29 is electrically connected to the first and second transmitters 24, 25 and the first and second receivers 26, 27. The connection unit 29 further has a plug-in terminal 291, which is a USB connector or a 1394 connector.

According to the above structure of the touch panel detection device, the first and second transmitters 24, 25 and the first and second receivers 26, 27 are one-to-one parallelly arranged and misaligned from each other. Accordingly, the infrared rays transmitted from the first and second transmitters 24, 25 are correspondingly projected to the misaligned first and second receivers 26, 27 to form light paths. In the conventional touch screen, the transmitters and receivers are parallelly arranged and aligned with each other. Therefore, the infrared rays transmitted from the transmitters are simply perpendicularly projected to the corresponding receivers. As a result, the range of light paths cannot be enlarged. This will cause detection blind corners on the substrate. In contrast, the space of the substrate of the present invention can be fully utilized to solve the problems of blind corners and vague touch that exist in the conventional touch screen.

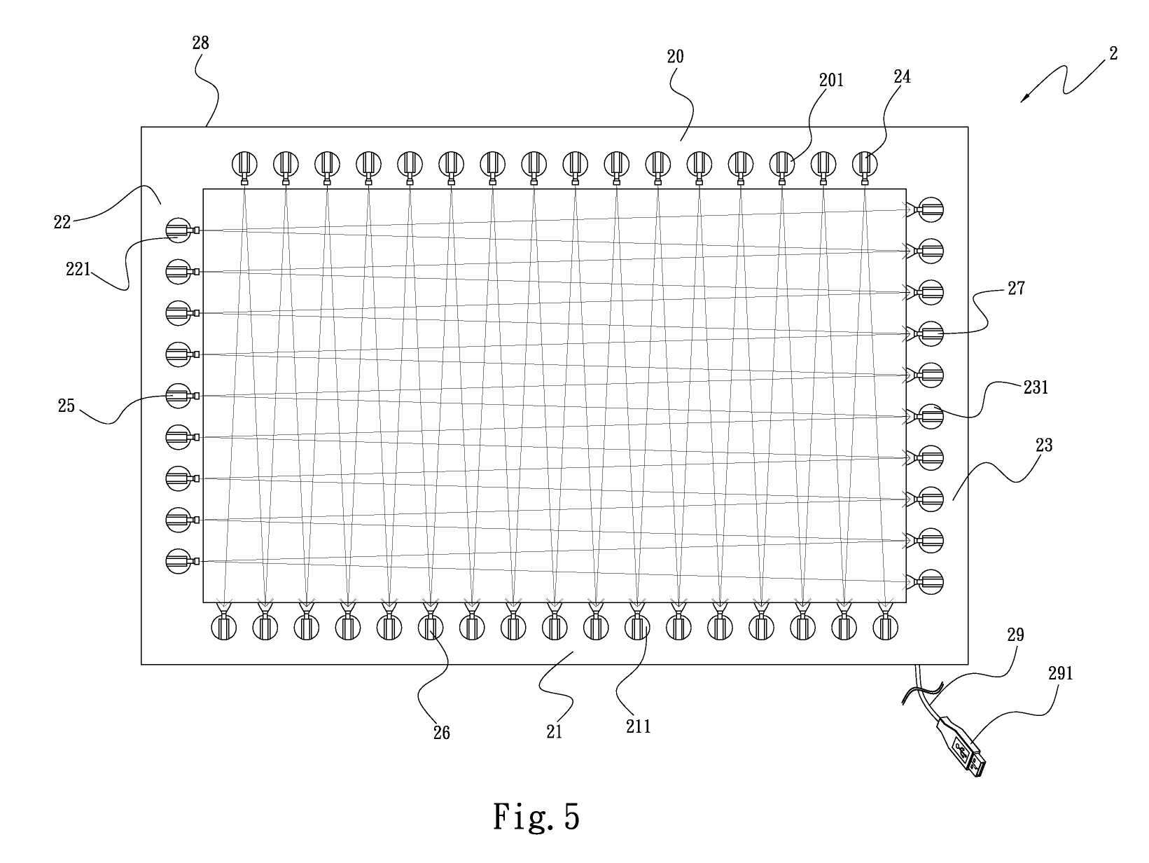

Please now refer to FIG. 5, which is a schematic diagram of a second embodiment of the touch panel detection device of the present invention. The second embodiment is partially identical to the first embodiment in components and the connection relationship between the components and thus will not be repeatedly described hereinafter. The second embodiment is mainly different from the first embodiment in that the infrared rays transmitted from the first transmitter 24 are projected to at least two corresponding first receivers 26, which are misaligned from the first transmitter 24. The infrared rays transmitted from the second transmitter 25 are projected to at least two corresponding second receivers 27, which are misaligned from the second transmitter 25 to form multiple light paths. This arrangement can also solve the problem of detection blind corners caused by the smaller range of light paths of the conventional touch screen in which the transmitters and receivers are parallelly arranged and aligned with each other and the infrared rays transmitted from the transmitters are simply perpendicularly projected to the corresponding receivers. Accordingly, the space of the substrate can be more efficiently utilized. Moreover, the problem of vague touch of the conventional touch screen can be solved.

Further referring to FIG. 5, the first receiver 26 can receive the infrared rays transmitted from at least two corresponding first transmitters 24, which are misaligned from the first receiver 26. The second receiver 27 can receive the infrared rays transmitted from at least two corresponding second transmitters 25, which are misaligned from the second receiver 27. This arrangement can also solve the problem of detection blind corners caused by the smaller range of light paths of the conventional touch screen in which the transmitters and receivers are parallelly arranged and aligned with each other and the infrared rays transmitted from the transmitters are simply perpendicularly projected to the corresponding receivers. Accordingly, the space of the substrate can be more efficiently utilized. Moreover, the problem of vague touch of the conventional touch screen can be solved.

In comparison with the conventional touch screen, the present invention has the following advantages:

1. The problem of blind corners is solved.

2. The problem of vague touch is improved.

3. The space of the substrate is more fully utilized.

The present invention has been described with the above embodiments thereof and it is understood that many changes and modifications in the above embodiments can be carried out without departing from the scope and the spirit of the invention that is intended to be limited only by the appended claims.

What is claimed is:

1. A touch panel detection device comprising:
a substrate, which is a frame body having a first side, a second side opposite to the first side, a third side and a fourth side opposite to the third side, at least one first fixing section and at least one second fixing section being respectively disposed on the first and second sides, at least one third fixing section and at least one fourth fixing section being respectively disposed on the third and fourth sides, the first and second fixing sections being parallelly arranged and misaligned from each other, the third and fourth fixing sections being parallelly arranged and misaligned from each other;
at least one first transmitter disposed on the first fixing section;
at least one second transmitter disposed on the third fixing section;
at least one first receiver disposed on the second fixing section;
at least one second receiver disposed on the fourth fixing section; and
a connection unit, a terminal of the connection unit being electrically connected to the first and second transmitters and the first and second receivers.

2. The touch panel detection device as claimed in claim 1, wherein two first receivers are respectively disposed on two second fixing sections of the second side for receiving signals transmitted from the first transmitter and two second receivers are respectively disposed on two fourth fixing sections of the fourth side for receiving signals transmitted from the second transmitter.

3. The touch panel detection device as claimed in claim 1, wherein the first and second transmitters transmit bifurcated light beams.

4. The touch panel detection device as claimed in claim 3, wherein bifurcated light beams transmitted from the first and second transmitters are infrared rays.

5. The touch panel detection device as claimed in claim 3, wherein the connection unit further has a plug-in terminal, which is a USB connector or a 1394 connector.
